(19) United States
(12) Patent Application Publication
(10) Pub. No.: US 2017/0305641 A1
(43) Pub. Date: Oct. 26, 2017

(54) DOUBLE-WALLED DRINKING VESSEL

(71) Applicant: Pi-Design AG, Triengen (CH)

(72) Inventor: Jørgen BODUM, Meggen (CH)

(21) Appl. No.: 15/529,756

(22) PCT Filed: Nov. 19, 2015
(86) PCT No.: PCT/EP2015/077067

§ 371 Date: May 25, 2017

(30) Foreign Application Priority Data
Nov. 27, 2014 (DE) 10 2014 224 270.3

(51) Int. Cl. B65D 81/38; B29C 65/70; A47G 19/22; B29L 31/00

(52) U.S. Cl. CPC B65D 81/3865; A47G 19/2288; A47G 19/2205; B29C 65/70; A47G 19/22; B29L 2031/7158

(57) ABSTRACT

The present invention relates to a double-walled drinking vessel for storing a drinkable liquid, in particular a hot beverage, comprising an inner container (12) having a wall (14) that encloses a cavity (16) for holding the liquid, has an outer surface (22), and defines a longitudinal axis (A), an outer container (26) at least partially enclosing the inner container (12), and a connecting piece (34), which is connected firmly to the outer container (26), wherein the connecting piece (34) is constructed such that it interacts with the outer surface (22) with a frictionally engaged fit and the outer container (26) can be detachably connected to the inner container (12).

### CROSS-REFERENCE TO RELATED APPLICATIONS

This application is a Section 371 of International Application No. PCT/EP2015/077067, filed Nov. 19, 2015, which was published in the German language on Jun. 2, 2016, under International Publication No. WO 2016/083226 A1 and the disclosure of which is incorporated herein by reference.

### BACKGROUND OF THE INVENTION

The present invention relates to a double-walled drinking vessel for storing a drinkable liquid, in particular a hot beverage, comprising an inner container having a wall, wherein the wall encloses a cavity for holding the liquid, has an outer surface, and defines a longitudinal axis, an outer container at least partially enclosing the inner container, and a connecting piece that is connected firmly to the outer container. The invention further relates to a double-walled drinking vessel for storing a drinkable liquid, in particular a hot beverage, comprising an inner container having a wall, wherein the wall encloses a cavity for holding the liquid, and defines a longitudinal axis, an outer container at least partially enclosing the inner container and having an inner surface, and a connecting piece that is connected firmly to the inner container.

Double-walled drinking vessels are then used, in particular, when a beverage is to be maintained at a certain temperature for a long time independent of the temperature of the surroundings. In many cases the user wants the beverage to have a temperature that is opposite the temperature of the surroundings. In summer he prefers a cool drink, while in winter he prefers a hot drink. Insulating vessels are constructed with double walls, especially because of the possibility to insert an insulating means, either air (stationary air is a relatively good insulator) or a different material having low heat conductivity, for example even the beverage container shown in WO 2010/003259A1. DE 1429954 A also shows an insulating vessel having a glass container, that is surrounded by an outer container. WO1998/004477A1 discloses a double-walled beverage container that is used, in particular for wine, to keep the liquid cool and thus to preserve its aroma. DE 196 25 690 A1 shows a double-walled glass container, in which both the inner and also outer containers are made of glass and are connected to each other directly by a positive fit. Other double-walled insulating vessels and/or drinking vessels are disclosed in US 2009/0078712 A1, U.S. Pat. No. 3,401,862 A, FR 2098662, WO 02/049 924 A2, DE 696 23 382 T2, and US 2004/0 007 553 A1.

One aspect of double-walled drinking vessels closely related to the insulating properties is that the drinking vessel can then also be used without the risk of burning the user's skin, if the cavity of the drinking vessel has been filled with a very hot drink, for example freshly brewed coffee. For paper drinking cups, which are often used by cafe operators for people taking coffee with them (“coffee to go”), it is known to place a protective ring, for example made of cardboard or plastic, around the drinking cup, in order to prevent burning the skin especially on a user's hands. In contrast to coffee-to-go drinking cups, drinking containers made of porcelain are preferably used within a café or restaurant, because they have a better aesthetic look and feel, they better match plates and other dishes, and they are reusable, which is why they have a better life cycle assessment and are therefore more sustainable than coffee-to-go drinking cups. Drinking vessels made of porcelain typically have a handle so there is a relatively low risk of burns even when freshly brewed coffee or some other hot beverage is poured in the vessel. However, there are also some coffee specialties that are typically poured into drinking vessels made of glass, for example, latte macchiato or milk (white) coffee. Drinking vessels made of glass can be provided with a handle only with a relatively large expense, so that the overwhelming majority of drinking vessels that are made of glass and are used for latte macchiato or milk coffee have no handle, so carrying them in the café is relatively difficult. Often the handle-less drinking vessel is placed on a saucer with which the user can carry the drinking vessel with the hot liquid from the counter to a seat. This produces a large risk that the drinking vessel falls from the saucer, for example if the user has to walk up or down stairs or if he bumps into another person in the café or restaurant. In addition to the trouble associated with a dropped drinking container, the hot liquid also represents an acute risk of burns not only for the user himself, but also for other persons nearby.

### BRIEF SUMMARY OF THE INVENTION

Therefore, the object of the present invention is to create a drinking vessel, which can still be easily and well gripped when a hot liquid is located in the drinking vessel. The drinking vessel should also be easy to manufacture, easy to connect to each other and to detach from each other, and should be reusable and have an appealing aesthetic appearance.

The object is achieved by a double-walled drinking vessel according to claims 1 and 2. Other advantageous constructions are the subject matter of the dependent claims.

According to the invention, the connecting piece of the double-walled drinking vessel according to the invention is constructed so that it interacts with the outer surface with a frictionally engaged fit and the outer container can be connected detachably to the inner container. In an alternative construction, the connecting piece is constructed so that it interacts with the inner surface with a frictionally engaged fit and the outer container can be connected detachably to the inner container.

The outer container has an essentially tubular construction and has at least one opening by which the inner container can be inserted into the outer container, in order to fasten the outer container to the inner container. According to the invention, the friction fit is created via the connecting piece and not directly by the outer container, wherein the connecting piece is constructed so that the connection between the outer container and the inner container is detachable. Because the outer container can be separated selectively from the inner container, it is possible without a problem to place the two containers separately from each other in a dishwasher and to clean them, without the risk of condensed water forming between the outer container and the inner container, which would lead to a visually adverse appearance and would make use in the restaurant industry more problematic. The formation of condensed water, especially when cleaning in a dishwasher, can be reliably prevented in double-walled drinking vessels only if the connection is absolutely leak-tight, as must be the case, for example, for the glass shown in WO 1998/004477A1. Other double-walled vessels in which the inner container is connected non-detachably to the outer container, are shown in US 2003/0029876 A1, DE 35 06 779 A1, and U.S. Pat. No. 2,981,430 A. It is technically nearly impossible to create a connection that is both absolutely leak-tight and can be frequently detached and closed again at will by a user. Therefore, because the connection according to the invention does not have to be hermetically sealed between the outer container and the inner container, the production of the drinking vessel is simplified. Furthermore, the inner container can be replaced without a problem by a new container, if it is damaged during operation, without having to replace the entire drinking vessel. It is further possible according to the invention to provide a handle-less drinking vessel that can also be gripped without the risk of burns, even when a hot drinkable liquid is filled into the cavity. The presence of a handle on the inner container is not required and not preferred according to the invention for connecting the outer container on the inner container. For production reasons, it is simpler to provide a handle on the outer container, which, however, is also not preferred and also not necessary for the reasons mentioned above.

The friction fit is generated exclusively by the contact of the connecting piece with the outer surface of the inner container or with the inner surface of the outer container. In contrast to the positive fit, no defined shape of the inner container and/or the outer container is required to connect the outer container to the inner container. The inner container can therefore be formed very easily, for example into a tube-like shape, whereby the production costs can be kept low. The holding force in the axial direction and acting between the connecting piece and the inner container can be increased by the coefficient of friction. This can be realized by roughening the outer surface or the inner surface and/or the surface of the connecting piece that is in contact with the outer or inner surface. In addition, the normal force acting perpendicularly on the outer or inner surface can be increased by a stronger deformation and especially by a stronger compression of the connecting piece, which likewise leads to an increased holding force. The stronger the compression, the more firmly the outer container is fastened on the inner container. The compression is determined essentially by the geometry of the connecting piece, for example by the oversize of the connecting piece in relation to the inner or outer container. The normal force resulting from a given compression is, in turn, dependent on the material of the connecting piece.

Preferably, the connecting piece has one or more flexible sections that contact the outer surface or the inner surface, when the outer container is connected to the inner container. The flexible sections can be dimensioned so that, on one hand, the outer container is fastened firmly enough on the inner container, so that it does not unintentionally detach from the inner container, but on the other hand, a high force is also not needed to detach the outer container from the inner container. It is not required to redesign the entire connecting piece when the holding force is to be changed, for example when the geometry of the inner container changes. It is sufficient to change only the dimensions of the flexible section, which simplifies the expense for changes. Here, the number of flexible sections can also be selected arbitrarily. For the case that one flexible section is not sufficient for fastening the outer container securely on the inner container, multiple flexible sections could be provided. The flexible sections can also be offset axially with respect to the longitudinal axis, whereby the position of the inner container can be uniquely defined relative to the outer container. In addition, the flexible section can comprise springs, which define the normal force acting on the inner container.

It is preferred when the flexible section or the flexible sections are constructed as radial surrounding ribs. Upon insertion of the inner container into the outer container the ribs are bent, whereby the ribs are loaded in tension on the outer bending radius and in compression on the inner bending radius. The ribs are thus not only compressed. Due to the stress conditions acting in the ribs, a normal force acting on the outer surface is generated, by which the outer container is fastened on the inner container.

The phrase “radial surrounding” should be understood to mean that a rib is closed and touches the inner container over its full surface, when the outer container is fastened on the inner container. In this way, it is ensured that the ribs contact the inner container over the entire circumference, so that the normal force and the holding force act uniformly over the periphery of the inner container. The stresses induced in the inner container due to these forces are consequently distributed uniformly, so that stress spikes and stress gradients are avoided. Damage to the inner container is largely avoided.

Alternatively, the flexible sections are constructed as segmented ribs. In comparison to a radial surrounding, closed rib, in this construction more ribs are provided that have the same position relative to the longitudinal axis, but can be uniformly distributed over the circumference. In this respect, multiple material-free openings are produced, so that material can be saved. The insertion of the inner container into the outer container is also made easier in comparison with the surrounding rib, because the air located between the inner container and the outer container can escape through the openings, and consequently the air in the intermediate space is not compressed. The same applies when separating the two containers, because a vacuum pressure is not generated between the inner container and the outer container.

In one preferred refinement, the connecting piece is made of or includes a flexible plastic, in particular an elastomer. For example, the elastomer can be a thermoplastic elastomer, in particular a thermoplastic rubber (TPR). With plastic the flexibility and the hardness of the connecting piece can be adapted to the existing requirements. The flexibility and the hardness are selected so that, on one hand, the outer container can be reliably fastened on the inner container under the loads typical during operation and, on the other hand, a user can detach the outer container from the inner container without too high an expenditure of force and without the risk of damage to the inner container. Due to the individual adjustability of the hardness and the flexibility, plastics and especially elastomers are the material of choice for preparing the connecting piece. Furthermore, the friction between the connecting piece and the inner container and thus the acting holding force is set by the flexibility or the hardness of the connecting piece.

It is preferred that the outer container is made of or includes a plastic, in particular a thermoplastic. In turn, the individual adjustability of the properties of plastic speaks for its use as the material for the outer container. For example, the color of the plastic can be varied without great expense. Engraving, for example for a company logo, can also be easily realized. In addition, plastics generally exhibit relatively poor heat conductivity, so that the use of plastic contributes to the insulation of the hot liquid in the inner container and it allows the user to grip the drinking vessel without the risk of burns. In contrast to glass, plastic is typically not brittle, so that the outer container protects the inner container from damage if the drinking vessel falls onto the floor. In particular, when the connecting piece interacts with the inner surface of the outer container for connecting the outer and the inner containers, the inner surface can already be provided with a defined structure in order to increase the roughness of the inner surface. This reinforces the connection between the inner and the outer containers.

Here, the connecting piece is advantageously formed by injection molding over the outer container. The molding can be implemented by an injection molding method, so that the connection between the connecting piece and the outer container can be produced in a simple manner. Alternatively, the connecting piece can be fastened in a purely mechanical way, such as mounting with a friction fit or with clips on the outer container. It could also be bonded. The selection of the connection is dependent, among other things, on the material of the outer container. Here, as the material for the outer container, preferably a thermoplastic, for example polypropylene, is used, because in connection with the injection molding, a stable connection between the outer container and the connecting piece can be produced in a simple manner.

In one preferred construction of the drinking vessel according to the invention, the outer container comprises an essentially tubular first container section and an essentially disk-shaped second container section. The use of the phrase “essentially” should be understood to mean that the shaping of the first and second container sections could also deviate somewhat from the strict geometric definition of “tubular” and “disk-shaped.” If the connecting piece is molded in the same injection molding method over the outer container, this will produce undercuts that will make it more difficult to remove the outer container from the injection molding tool. These undercuts can be reduced by a two-part construction of the outer container, so that the outer container and the injection-molded connecting piece can be produced without a problem in the same injection molding tool and can be removed from this tool together, whereby the production process is simplified and more economical.

Here, it is preferred when the first and the second container section are welded to each other. This method presents itself when the plastic that is used for the outer container can be used in welding processes, which is generally possible for thermoplastic materials. In contrast to other joining methods, such as bonding, welding leads to a long-lasting and reliable connection and is also easy to implement from a production-related viewpoint.

In an alternative construction, the outer container is made of or includes metal. The use of metal as the material for the outer container can be for aesthetic reasons, in order to give the drinking vessel a high-quality look and feel. In addition, metal is a very durable material, so that the outer container can be used for a very long time and frequently, without signs of significant wear and tear becoming visible. Metal also distinguishes itself as a material by high temperature resistance and acid/base resistance and high thermal shock resistance, so that frequent cleaning, even at high temperatures and with relatively aggressive cleaning agents, has no visible effects on the outer container. This construction is suitable, in particular, for use in the restaurant industry. The outer container can be made either completely or partially from metal. It is possible, for example, to produce the outer container from plastic and to provide it with a metal coating. Metal is especially well suited for connecting the connecting piece to the outer container by clips or connectors.

The inner container can be made of or include glass, porcelain, plastic, or metal. A benefit of glass is its transparency, so that the user can easily see how much of the drinkable liquid is still in the drinking vessel. It also provides advantages for the service personnel in the restaurant industry. Its high resistance to chemicals gives glass advantages especially in the cleaning process, because even harsher cleaning agents, which might be required in the restaurant industry for hygienic reasons, can be used. Because glass is essentially inert, it absorbs no ingredients from the drinkable liquid and also does not emit any to the liquid. In this respect, glass has flavor neutral effects. Porcelain has the same advantages as glass except for transparency. The advantages of metals and plastics were already mentioned in connection with the outer container.

In one advantageous construction, the connecting piece is constructed so that an intermediate space is formed between the inner container and the outer container. Just based on the increased space between the outer container and the inner container due to the intermediate space and the resulting reduced heat conduction, a user can also reliably grip the drinking vessel when the inner container is filled with a hot liquid. As already mentioned above, stationary air is a relatively good insulator, so that air in the intermediate space provides good insulation for the hot liquid from the outer container. Consequently, the heat conduction from the inner container to the outer container is reduced, so that a user can touch the drinking vessel without the risk of burning his skin. The more airtight the connecting piece seals the intermediate space, the less heat is dissipated from the inner container or supplied to the inner container and therefore the longer the temperature of the liquid is maintained, which is realized especially when the connecting piece completely surrounds the inner container and seals the intermediate space.

Here, the outer container can have a hole passing through its wall. This guarantees the air exchange between the intermediate space and the surroundings. This is important for the processes for connecting and disconnecting the outer container from the inner container, in order to prevent the compression of the air and the formation of a vacuum pressure, especially when the flexible sections are constructed as radial surrounding ribs.

Advantageously, the connecting piece has a recess into which the outer container can be inserted. The recess makes sure that the connecting piece is positioned uniquely relative to the outer container. The corresponding position of the outer container can have an oversize with respect to the recess, so that a frictionally engaged plug-in connection can be provided between the outer container and the connecting piece. Because of the ability to position the connecting piece uniquely relative to the outer container, the projection helps to keep deviations in series production as small as possible when connecting the connecting piece to the outer container.

In one refinement of the drinking vessel according to the invention, the wall of the inner container has an opening for filling and pouring the drinkable liquid and has, with respect to the longitudinal axis, two or more segments having different diameter, wherein a first segment has a first diameter and a second segment has a second diameter that is smaller than the first diameter; the first segment is arranged with respect to the opening along the longitudinal axis in front of the second segment and the connecting piece interacts in the second segment with the outer surface. In this context “segments” are understood to be sections or areas of the inner container. At the transition from the first segment to the second, the inner container is tapered in this refinement, so that a step is produced there against which the outer container contacts when the inner container is inserted into the outer container. If the outer container contacts the step, it is positioned as desired along the longitudinal axis relative to the inner container. In this way, a clear signal is given to the user how far the inner container must be inserted into the outer container to provide a secure connection. The position of the step and the length of the outer container are here preferably adjusted to each other so that, between the disk-shaped second container section of the outer container and the base of the inner container, a space remains so that the intermediate space also extends between the second container section and the base of the inner container. In this way, it is ensured that the heat conduction from the inner container to the outer container and then to the surroundings is significantly reduced. This is important, because it can happen that the user puts the drinking vessel down on a base that is cold or has good heat-conducting properties, which would quickly cool the drinkable liquid and especially the hot beverage. This cooling is significantly slowed in this refinement.

One preferred alternative distinguishes itself in that the wall has a third segment having a third diameter, which is arranged with respect to the opening along the longitudinal axis beyond the second segment, and the third diameter is greater than the second diameter and smaller than the first diameter. The second segment thus lies in an indentation and is surrounded by segments that have a larger diameter. If the outer container is pushed onto the inner container, then the connecting piece is initially deformed relatively strongly in the third segment, so that the user must apply a relatively high force in the axial direction onto the inner container and/or the outer container, in order to overcome the holding force and to shift the two containers against each other. Shortly before the outer container contacts the step, the compression of the connecting element and thus the holding force decreases as soon as it has reached the second segment, so that the user receives a unique signal that the outer container is located in the correct position relative to the inner container. In the reverse situation, for loosening the outer container from the inner container, a higher force is required when the connecting piece is pushed by the third segment. The increased holding force prevents the outer container from unintentionally detaching from the inner container, for example when the plastic is aged and becomes brittle and thus no longer can generate the required holding force in the second segment.

In an alternative construction, the wall has a third segment having a third diameter, which is arranged with respect to the opening along the longitudinal axis beyond the second segment, and the third diameter is smaller than the second diameter. Consequently, in the third segment the connecting piece is less thick than in the second segment or depending on the selection of the third diameter not compressed at all. The forces to be applied when inserting the inner container into the outer container are therefore very low and increase significantly when the connecting piece reaches the second segment. In this way, the user also receives a signal that the connecting piece is interacting with the second segment. Conversely, the outer container can be easily detached from the inner container.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 a first embodiment of a drinking vessel according to the invention in an unassembled state,

FIG. 2 the first embodiment shown in FIG. 1 of the drinking vessel according to the invention in the assembled state,

FIG. 3 a second embodiment of the drinking vessel according to the invention in the assembled state,

FIG. 4 a third embodiment of the drinking vessel according to the invention in the assembled state,

FIG. 5 a fourth embodiment of the drinking vessel according to the invention in the assembled state, and

FIG. 6a fifth embodiment of the drinking vessel according to the invention in the assembled state.

### DETAILED DESCRIPTION OF THE INVENTION

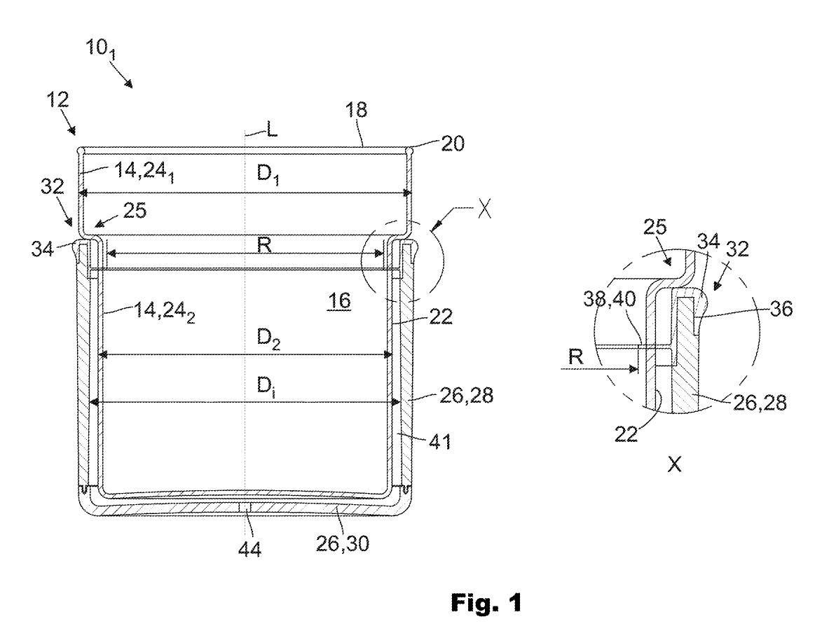

In FIG. 1, a first embodiment of a double-walled drinking vessel 10₁ according to the invention for storing a drinkable liquid, in particular a hot beverage, is shown using a side sectional representation. The drinking vessel 10₁ comprises an inner container 12 having a wall 14 that encloses a cavity 16. The wall 14 forms an opening 18 through which the drinkable liquid is filled into the cavity 16 and can be poured out from the cavity 16. The opening 18 is surrounded by a drinking edge 20. Furthermore, the wall 14 has an outer surface 22 and defines a longitudinal axis L of the drinking vessel 10₁.

In the embodiment shown in FIG. 1, the wall 14 of the inner container 12 has a first segment 24₁ having a first diameter D₁ and a second segment 24₂ having a second diameter D₂, wherein the second diameter D₂ is smaller than the first diameter D₁. With respect to the opening 18 the second segment 24₂ is arranged beyond the first segment 24ₖ. The diameter D should relate to the outer surface 22, thus it should represent the outer diameters of the respective segments 24 and comprise the wall thickness of the wall 14. At the transition between the two segments 24₁ and 24₂, the wall 14 runs nearly perpendicular to the longitudinal axis L, so that a step 25 is produced.

In addition, the drinking vessel 10₁ comprises an outer container 26 that has an essentially tubular first container section 28 and an essentially disk-shaped second container section 30 that are connected firmly to each other. The connection can be constructed as a plug-in connection or as an adhesive connection. However, because the two container sections 28, 30 are preferably produced from a plastic, depending on the plastic being used, the connection could also be constructed as a weld connection.

At an open end 32 of the first container section 28 there is a connecting piece 34, which is shown enlarged in the detail section X. The connecting piece 34 has a recess 36 in which the outer container 26 can be inserted with the first section 28. In the area of the open end 32 that is surrounded by the connecting piece 34, the outer container 26 in the first container section 28 has a reduced wall thickness (see detail X). The wall thickness decreases stepwise, namely once from the inner side and once from the outer side of the outer container 26. The connecting piece 34 can be connected to the outer container 26 by a friction fit or also by other joining methods, such as welding or bonding. Alternatively, the connecting piece 34 could be molded onto the outer container 26.

The connecting piece 34 has a flexible section 38 that is constructed, in the shown embodiment, as a radial surrounding rib 40. The phrase “radial surrounding” should be understood to mean that the rib 40, in a top view, has a ring-like shape and is constructed without breaks. Even though the inner container 12 is shown together in FIG. 1, the rib 40 is shown in a starting position that it assumes in the non-assembled state, that is, when the inner container 12 is not connected to the outer container 26, which will be explained in more detail below.

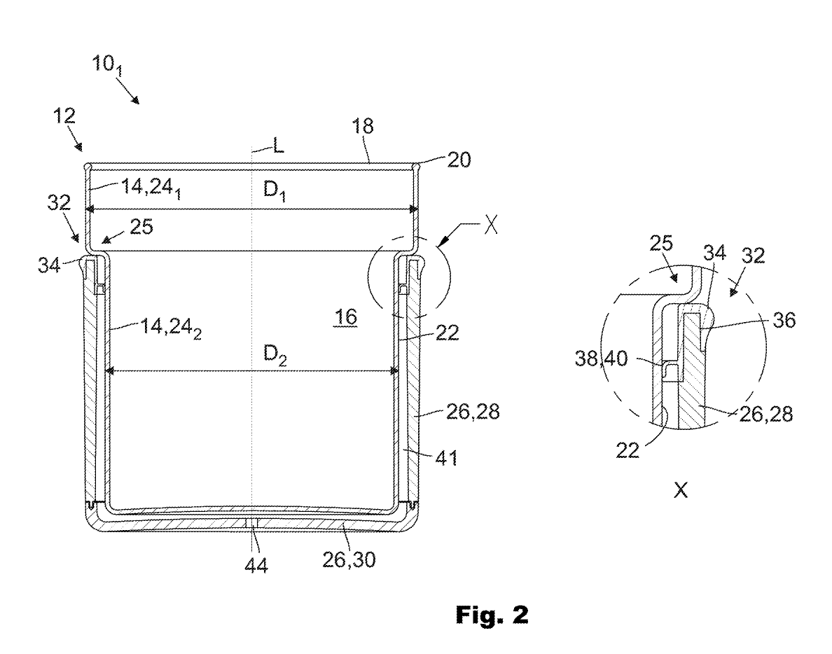

In FIG. 2, the first embodiment of the drinking vessel 10₁ according to the invention is shown in the assembled state. The phrase “assembled state” should be understood to mean the state in which the outer container 26 is fastened to the inner container 12. To fasten the outer container 26 to the inner container 12, the inner container 12 is inserted through the open end 32 of the first container section 28 into the outer container 26 until the connecting piece 34 contacts the step 25. The user could indeed insert the inner container 12 less far into the outer container 26, but the step 25 offers him a good orientation aid for how the outer container 26 must be positioned axially relative to the inner container 12, in order to guarantee a more secure connection.

As can be seen in FIG. 1, viewed from the connecting piece 34, the rib 40 runs radially inward and in the starting position approximately perpendicular to the longitudinal axis L. It can be further seen that the rib 40 projects radially inward past the inner container 12, that is, has an oversize. In other words, the radial inner end of the rib 40 forms a rib inner diameter R that is smaller than the second diameter D₂ of the wall 14 in the second segment 24₂. The result of this is that, while inserting the inner container 12 into the outer container 26, the rib 40 is bent toward the disk-shaped second container section 30 of the outer container 26 and consequently partially contacts the outer surface 22 of the inner container 12, as can be seen in FIG. 2. This profile is designated the final position. Due to the stress relationships resulting in the rib 40 and its flexibility, it tries to return to its starting position. In this way, a normal force is applied onto the outer surface 22 of the inner container 12. Consequently, between the outer surface 22 and the part of the rib 40 that contacts the outer surface 22, there is a holding force that acts along the longitudinal axis L and ensures that the outer container 26 is mounted detachably on the inner container 12. The holding force must be overcome by the user in order to insert the inner container 12 into the outer container 26 so far that it contacts the step 25.

The second diameter D₂ is smaller than the inner diameter D₁ of the outer container 26, so that an intermediate space 41 remains between the inner container 12 and the outer container 26.

The holding force can be controlled, among other things, by the properties of the contacting surfaces, especially their roughness, and by the degree of flexibility or the hardness of the rib 40. Furthermore, the length and thickness of the rib 40 are important for the holding force. In the shown example the connecting piece 34 has only one rib 40, but two or more ribs could also be provided, which could be offset axially and not necessarily radially closed, but instead could be segmented.

For detaching the outer container 26 from the inner container 12, the two containers 26 are pulled away from each other.

To prevent the air in the intermediate space 41 from being compressed when the inner container 12 is inserted into the outer container 26 and to prevent the air from forming a vacuum pressure when removing the two containers 12, 26 from each other, a hole 44 is provided in the outer container 26, which runs completely through the outer container 26. Air can be pushed out from the intermediate space 41 through the hole 44 upon connection and can be sucked into the intermediate space upon separation, so that the connecting and disconnecting process can be performed with relatively little force.

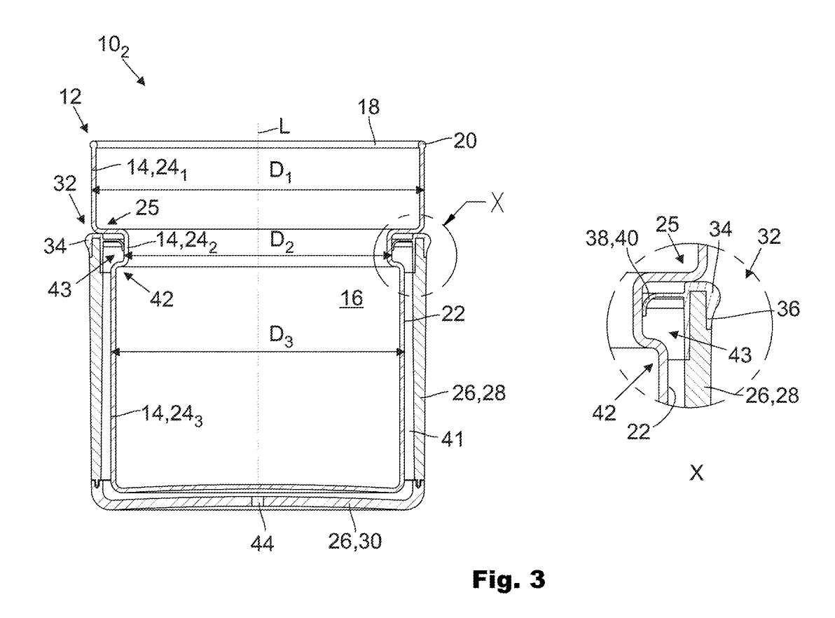

In FIG. 3, a second embodiment of the drinking vessel 10₂ according to the invention is shown using a side sectional representation. In comparison to the first embodiment 10₁, the wall 14 of the inner container 12 has, in addition to the first and second segments 24₁ and 24₂, a third segment 24₃ that is arranged with respect to the opening 18 beyond the second segment 24₂. The third segment 24₃ has a third diameter D₃ that is greater than the second diameter D₂ but smaller than the first diameter D₁. At the transition from the second segment 24₂ into the third segment 24₃, the inner container 12 forms another step 42. The second segment 24₂ thus forms an indentation 43 that is surrounded by a segment 24 having larger diameter D. In comparison to the first embodiment 10₁, the second diameter D₂ is smaller, so that consequently also the rib inner diameter D₁ is selected smaller and the rib 40 has a larger radial extent (not shown explicitly). This ensures that the holding force is sufficiently large to mount the outer container 26 securely on the inner container 12.

When inserting the inner container 12 into the outer container 26, a somewhat different situation is presented to the user in comparison with the first embodiment 10₁. While in the first embodiment 10₁ the rib 40 is essentially always opposed to the same axial holding force to be overcome when inserting the inner container 12 until the outer container 26 contacts the step 25, the holding force is greater in the third segment 24₃ than in the second segment 24₂ due to the stronger bending of the rib 40. The user thus feels a relatively abrupt change of the holding force to be overcome when the rib 40 transitions from the third segment 24₃ into the second segment 24₂. This is a clear sign for the user that the outer container 26 is nearly contacting the step 25 and thus has reached its provided position.

When detaching the containers, an inverse sequence of the holding forces to be overcome is presented. In particular, the rib 40 must be guided over the additional step 42, which is associated with a noticeably increased expenditure of force. The additional step 42 and the third segment 24₃ having the larger third diameter D₃ ensure that the outer container 26 cannot unintentionally or uncontrollably detach from the inner container 12.

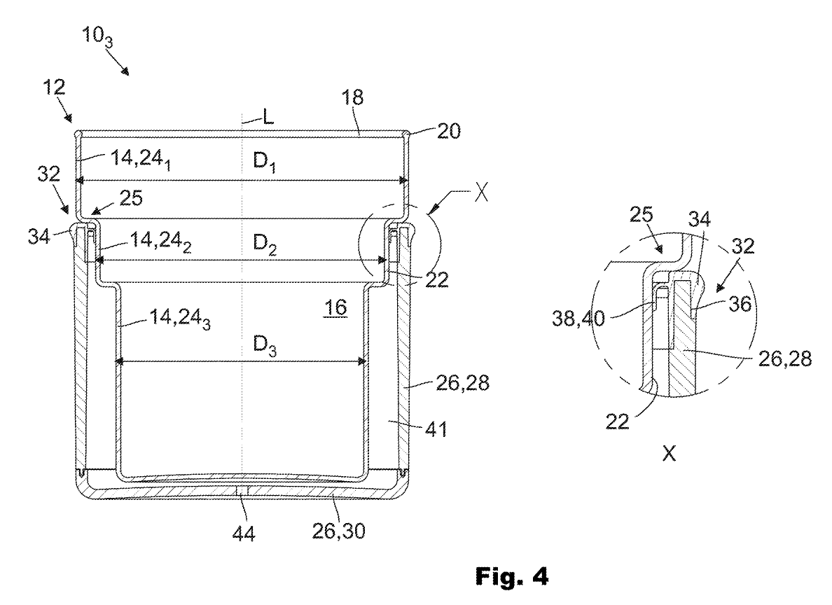

In FIG. 4, a third embodiment of the drinking vessel 10₃ according to the invention is shown. The wall 14 of the inner container 12 likewise has three segments 24₁ to 24₃, wherein the third diameter D₃ of the third segment 24₃ is smaller than the second diameter D₂ of the second segment 24₂. In this case the third diameter D₃ is smaller than the rib internal diameter D₁ not shown explicitly, so that the rib 40 is not yet bent in the third segment 24₃ and thus the user does not have to overcome a holding force. Only when the rib 40 enters into the second segment 24₂ must the user overcome the holding force acting between the outer surface 22 and the rib 40. The distance to the step 25 is then no longer large, so that the outer container 26 can be quickly connected to the inner container 12 and can be detached from it.

In all cases the diameters D₁, D₂, and/or D₃ remain constant within the associated segments 24₁ to 24₃, so that the segments 24₁ to 24₃ are cylindrical. Alternatively, the diameters D₁, D₂, and/or D₃ can change within one of the segments 24₁ to 24₃, so that the segments have, for example, the shape of a truncated cone. Obviously, the inner container can have more than three segments 24. In addition, the outer container 26 can also comprise segments having different diameters.

In all cases, the position of the step 25 is adjusted to the length of the outer container 26 so that the intermediate space 41 is formed not only between the first container section 28 and the inner container 12, but also between the second container section 30 and the inner container 12. Consequently, the outer container 26 and the inner container 12 are contacted only by the connecting piece 34.

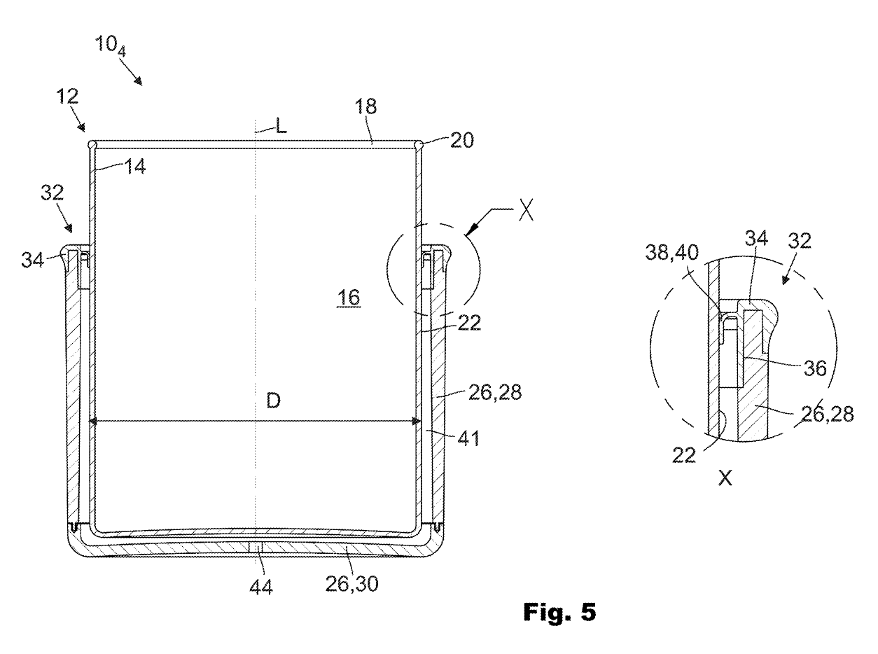

In FIG. 5, a fourth embodiment of the drinking vessel 10₄ according to the invention is shown, wherein the wall 14 of the inner container 12 has no diameter changes and no segments. Consequently, the user is free in the axial positioning of the outer container 26 relative to the inner container 12 until the inner container 12 contacts the second container section 30. In this embodiment, due to the lack of the step 25, it is not guaranteed that the intermediate space 41 is also formed between the second container section 30 and the inner container 12.

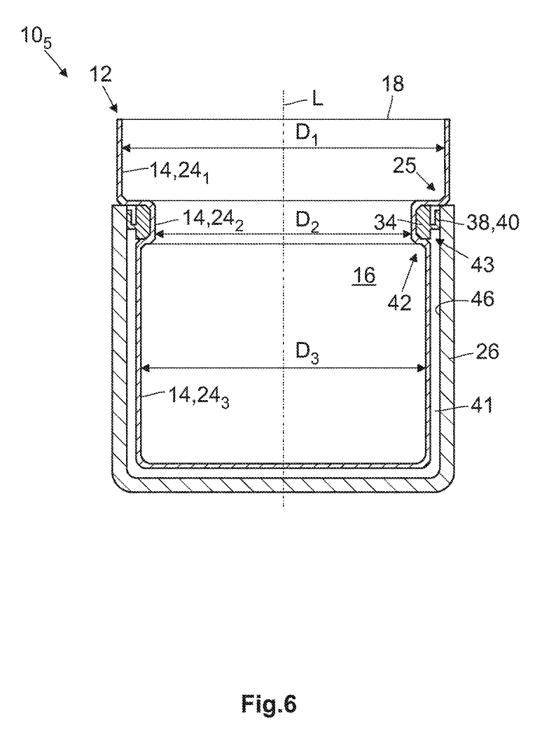

In FIG. 6, a fifth embodiment of the drinking vessel 10₅ according to the invention is shown, which is largely the same as the second embodiment 10₂ shown in FIG. 3. In contrast to the second embodiment, however, in the fifth embodiment 10₅ the connecting piece 34 is arranged in the indentation 43 of the inner container 12. The connecting piece 34 can have a certain amount of elasticity, so that it can be pushed with a suitable tool over the third segment 243 of the inner container 12 into the indentation 43. The ribs 40 point outward and then interact with an inner surface 46 of the outer container 26, when the outer container 26 is connected to the inner container 12. While the ribs 40 in the other embodiments of the drinking vessel 10₁ to 10₄ are tilted toward the base of the drinking vessel for connecting the outer container 26 to the inner container 12, in the fifth embodiment of the drinking vessel 10₅ they are turned toward the opening 18.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A double-walled drinking vessel for storing a drinkable liquid, especially a hot beverage, the drinking vessel comprising:
an inner container (12) having a wall (14), wherein the wall (14) encloses a cavity (16) for holding the liquid, has an outer surface (22), and defines a longitudinal axis (L),
an outer container (26) at least partially enclosing the inner container (12), and
a connecting piece (34) that is connected firmly to the external container (26), wherein the connecting piece (34) is constructed such that the connecting piece interacts with the outer surface (22) with a frictionally engaged fit the outer container (26) being detachably connected to the inner container (12).

2. A double-walled drinking vessel for storing a drinkable liquid, especially a hot beverage, the drinking vessel comprising:
an inner container (12) having a wall (14), wherein the wall (14) encloses a cavity (16) for holding the liquid, and defines a longitudinal axis (L),
an outer container (26) at least partially enclosing the inner container (12) and having an inner surface (46), and
a connecting piece (34) that is connected firmly to the inner container (12), wherein the connecting piece (34) is constructed such that the connecting piece interacts with the inner surface (46) with a frictionally engaged fit the outer container (26) can be being detachably connected to the inner container (12).

3. The double-walled drinking vessel according to claim 1, wherein the connecting piece (34) has one or more flexible sections (38) that contact at least one of the outer surface (22) and the inner surface (46) when the outer container (26) is connected to the inner container (12).

4. The double-walled drinking vessel according to claim 3, wherein the flexible sections (38) are constructed as radial surrounding ribs (40).

5. The double-walled drinking vessel according to claim 3, wherein the flexible sections are constructed as segmented ribs.

6. The double-walled drinking vessel according to claim 1, wherein the connecting piece (34) is made of or includes a flexible plastic, in particular an elastomer.

7. The double-walled drinking vessel according to claim 1, wherein the outer container (26) is made of or includes a plastic, in particular a thermoplastic.

8. The double-walled drinking vessel according to claim 6, wherein the connecting piece (34) is molded on by injection molding over the outer container (26).

9. The double-walled drinking vessel according to claim 6, wherein the outer container (26) comprises a tubular first container section (28) and a disk-shaped second container section (30).

10. The double-walled drinking vessel according to claim 9, wherein the first and the second container sections (28, 30) are welded to each other.

11. The double-walled drinking vessel according to claim 1, wherein the outer container (26) is made of or includes metal.

12. The double-walled drinking vessel according to claim 1, wherein the inner container (12) is made of a material selected from the group consisting of glass, porcelain, plastic, and metal.

13. The double-walled drinking vessel according to claim 1, wherein the connecting piece (34) is constructed such that an intermediate space (41) is formed between the inner container (12) and the outer container (26).

14. The double-walled drinking vessel according to claim 13, wherein the outer container (26) has a hole (44) passing through its wall.

15. The double-walled drinking vessel according to claim 1, wherein the connecting piece (34) has a recess (36) in which the outer container (26) can be inserted.

16. The double-walled drinking vessel according to claim 1, wherein the wall (14) of the inner container (12) forms an opening (18) for filling and pouring the drinkable liquid and has, with respect to the longitudinal axis (L), two or more segments (24) having different diameters (D), wherein a first segment (241) has a first diameter (D1) and a second segment (242) has a second diameter (D2) that is smaller than the first diameter (D1), the first segment (241) is arranged, with respect to the opening (18), along the longitudinal axis (L) before of the second segment (242), and the connecting piece (34) interacts with the outer surface (22) in the second segment (242).

17. The double-walled drinking vessel according to claim 16, wherein the wall (14) has a third segment (24₃) having a third diameter (D₃), which is arranged, with respect to the opening (18), along the longitudinal axis (L) beyond the second segment (24₂) and the third diameter (D₃) is greater than the second diameter (D₂) and less than the first diameter (D₁).

18. The double-walled drinking vessel according to claim 16, wherein the wall (14) has a third segment (24₃) having a third diameter (D₃), which is arranged, with respect to the opening (18), along the longitudinal axis (L) beyond the second segment (24₂) and the third diameter (D₃) is smaller than the second diameter (D₂).
